(19) United States
(12) Patent Application Publication
(10) Pub. No.: US 2008/0123929 A1
(43) Pub. Date: May 29, 2008

(54) APPARATUS, METHOD AND PROGRAM FOR IMAGE TYPE JUDGMENT

(75) Inventor: Yoshiro KITAMURA, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/772,387

(22) Filed: Jul. 2, 2007

(30) Foreign Application Priority Data
Jul. 3, 2006 (JP) 2006-183164
Jul. 3, 2006 (JP) 2006-183165

(51) Int. Cl. G06K 9/00

(52) U.S. Cl. 382/132; 382/155

(57) ABSTRACT

Judgment means for judging which of a plurality of image types, predefined by one or more items out of radiographed parts, radiography directions, and radiography methods a target image belongs to, according to characteristic quantities of the target image is generated and prepared through machine learning using sample images belonging to each of the image types, and an image type of a radiograph included in an input image is judged by applying the judgment means to the radiograph.

### BACKGROUND OF THE INVENTION

1. Field of the Invention

The present invention relates to an apparatus, a method and a program for judging an image type of a target radiograph out of various image types defined by radiographed parts, radiography directions, radiography methods, and the like.

2. Description of the Related Art

Methods of carrying out appropriate image processing on radiographs read by CR systems or the like have been used, to cause the radiographs to become optimal for image interpretation.

For example, a method has been used wherein image recognition processing appropriate for a radiograph is carried out on the radiograph according to image data representing the radiograph and radiography menu information representing the type of the radiograph, and image processing appropriate for the radiograph is carried out thereon based on a result of the image recognition processing, in order to obtain a radiograph in a state optimal for image interpretation.

Radiography menu items refer to codes defined in detail by radiographed parts, radiography directions, radiography methods, and the like, and are generally input by a user (a radiography technician or the like) at the time of radiography. Image recognition processing and image processing on a target radiograph are different depending on the items selected in the radiography menus, and the type of image recognition processing and parameters for image processing that are optimal for a radiograph are prepared for each of the radiography menu items. Recognition of segmented-field radiography, radiation field recognition, histogram analysis, and the like are used as the image recognition processing while density/gradation processing, frequency processing, noise reduction processing, and the like are mainly used as the image processing.

The radiography menu information and the image recognition processing are input and carried out for the following reason. In diagnoses using radiographs, regions of interest in subjects are different for users (radiologists and the like), and density in the regions of interest may change, depending on radiographed parts and radiography directions in the radiographs. For example, radiographs corresponding to bone tissues have comparatively low density while radiographs corresponding to soft tissues have comparatively high density. Therefore, a range of density to be enhanced by image processing is different between bones and soft tissues as the region of interest. In order to know the density range to be enhanced, the radiography menu information is necessary, and histogram analysis or the like is necessary to know a high or low density region. In addition, in the case where a radiation field is narrowed by a mask as a radiation field stop (hereinafter referred to as a radiation field mask), for example, histogram information cannot be obtained correctly due to a low density range in a comparatively wide region outside the radiation field. However, if histogram analysis is carried out based on image information only from the radiation field after recognition of the radiation field in a radiograph, the radiograph can be provided in a state where a more preferable density range has been enhanced (see Japanese Unexamined Patent Publication No. 10(1998)-162156).

Meanwhile, the radiography menu items (the codes) defined by radiographed parts, radiography directions, radiography methods, and the like vary among radiographs, and manual input thereof is a substantially troublesome operation for a user. Therefore, in order to automatically set the radiography menu items, methods of judging radiography directions toward subjects in radiographs have been studied, and a method of recognition of a frontal or lateral image has been proposed for the case of chest as a radiographed part of a subject (see Japanese Unexamined Patent Publication No. 5(1993)-184562). Furthermore, a method of determining image processing conditions has been proposed (see Japanese Unexamined Patent Publication No. 2002-008009).

However, the method described in Japanese Unexamined Patent Publication No. 5(1993)-184562 is a method that is specific only to recognition of a frontal or lateral image of a human chest. Therefore, images corresponding to actual various radiography menu items, such as an image of neck bones, a simple chest X-ray, an image of a chest radiographed laterally, an image of the chest of an infant or toddler, an image of a breast, an image of the abdomen of an infant, an image of lumbar bones radiographed from the front or laterally, and an image of a hip joint, cannot be judged. Moreover, image recognition corresponding to such various radiography menus has been difficult by use of any conventional recognition method.

### SUMMARY OF THE INVENTION

The present invention has been conceived based on consideration of the above circumstances. An object of the present invention is therefore to provide an apparatus, a method, and a program for judging an image type of a radiograph out of various image types defined by radiographed parts, radiography directions, radiography methods, and the like.

An image type judgment apparatus of the present invention comprises:

judgment means for judging which of a plurality of image types, predefined by one or more items out of radiographed parts, radiography directions, and radiography methods a target image belongs to, based on various kinds of characteristic quantities in the target image, the judgment means generated through machine learning using sample images belonging to each of the image types and prepared for each of the image types; and

judgment processing means for carrying out judgment on which of the image types a radiograph included in an input image belongs to by applying the judgment means to the radiograph.

The image type judgment apparatus of the present invention may further comprise:

mask boundary detection means for detecting a boundary between a radiation field mask and a radiation field in the radiograph, based on the input image including the radiograph; and

image density correction means for carrying out density correction that causes densities of images in two neighboring regions sandwiching the detected boundary in the radiograph to become closer to each other. In this case,

the judgment processing means judges the image type of the radiograph by applying the judgment means to the radiograph having been subjected to the density correction.

The image type judgment apparatus of the present invention may comprise:

the mask boundary detection means for detecting the boundary between the radiation field mask and the radiation field in the radiograph, based on the input image including the radiograph; and

characteristic quantity adjustment means for adjusting values of the characteristic quantities in a region over the detected boundary in the radiograph so as to suppress contribution of the characteristic quantities to the judgment.

In the image type judgment apparatus of the present invention, the judgment means may be classifiers of various types each having a different detection target and generated through machine learning using sample images belonging to one of the image types as the detection target thereof and sample images belonging to an image type different from the image type as the detection target, while the judgment processing means may carry out the judgment by applying at least one of the classifiers to the radiograph.

In the image type judgment apparatus of the present invention, a method called boosting may be a method of the machine learning, for example. Especially, a method called Adaboost as a modification of boosting is preferable. Alternatively, the machine learning method may be a method for generating a support vector machine or a neural network.

The judgment means in the present invention is a classifier that is generated through the machine learning and judges whether the target image is an image belonging to a predetermined one of the image types, and may comprise classifiers of various types whose detection-target image types are different or a classifier that is generated through the machine learning and can judge at once which of the image types the target image belongs to.

In the image type judgment apparatus of the present invention, it is preferable for the various kinds of characteristic quantities to include an edge characteristic quantity representing a direction and/or a position of an edge component in the radiograph.

The edge characteristic quantity may include a characteristic quantity representing a position of the boundary between the radiation field mask and the radiation field in the radiograph or a boundary position of a field in the radiograph in the case where the radiograph has been generated by image stitching.

It is preferable for the various kinds of characteristic quantities to include an image-corresponding region size representing a size of an actual region represented by the radiograph and a density distribution characteristic quantity representing an index regarding density distribution in the radiograph.

It is also preferable for the various kinds of characteristic quantities to include at least one of a characteristic quantity representing a density histogram of the radiograph and a characteristic quantity representing an edge component in the radiograph.

Boosting, and Adaboost as a modification thereof, have been described in Japanese Unexamined Patent Publication No. 2005-100121 or the like, which will be outlined below.

Here is described the case of learning for classification of data points distributed in a characteristic quantity plane having axes corresponding to two characteristic quantities x1 and x2 into data points of specific content and data points other than the data points of the specific content. In boosting, a first set of data points is selected from a sample data-point group comprising data points known to represent data of the specific content and data points other than those, and a first straight line or comparatively simple curve that most favorably classifies the data points of the first set is specified in the characteristic quantity plane. Thereafter, a second set of data points that cannot be favorably classified by the first line or curve is selected, and a second straight line or curve that most favorably classifies the data points in the second set is specified. By repeating these procedures, the learning is carried out. An optimal line that divides the characteristic quantity plane is finally determined according to rule of majority or the like, by using all the straight lines or curves having been specified through the procedures. On the other hand, a weight is assigned in Adaboost for each of the data points comprising the same sample data-point group, and a first straight line or curve that best classifies all the data points is found in the characteristic quantity plane. The weight is increased for each of the data points that has not been classified correctly by the first straight line or curve, and a straight second line or curve that best classifies the data points is found with the weights being considered. By repeating these procedures, the learning is carried out.

An image type judgment method of the present invention comprises the steps of:

generating judgment means for judging which of a plurality of image types, predefined by one or more items out of radiographed parts, radiography directions, and radiography methods a target image belongs to, based on various kinds of characteristic quantities in the target image, the judgment means generated through machine learning using sample images prepared for each of the image types; and

carrying out judgment on which of the image types a radiograph included in an input image belongs to by applying the judgment means to the radiograph.

After the step of generating the judgment means, the image type judgment method of the present invention may further comprise the steps of:

detecting a boundary between a radiation field mask and a radiation field in the radiograph, based on the input image including the radiograph; and

carrying out density correction that causes densities of images in two neighboring regions sandwiching the detected boundary in the radiograph to become closer to each other. In this case,

the step of carrying out judgment is the step of carrying out judgment on the image type of the radiograph by applying the judgment means to the radiograph having been subjected to the density correction.

After the step of generating the judgment means, the image type judgment method of the present invention may comprise the steps of:

detecting the boundary between the radiation field mask and the radiation field in the radiograph, based on the input image including the radiograph; and

adjusting values of the characteristic quantities in a region over the detected boundary in the radiograph so as to suppress contribution of the characteristic quantities to the judgment

A program of the present invention causes a computer to function as:

judgment means for judging which of a plurality of image types, predefined by one or more items out of radiographed parts, radiography directions, and radiography methods a target image belongs to, based on various kinds of characteristic quantities in the target image, the judgment means generated through machine learning using sample images prepared for each of the image types; and

judgment processing means for carrying out judgment on which of the image types a radiograph included in an input image belongs to by applying the judgment means to the radiograph.

The program of the present invention may cause the computer to further function as:

mask boundary detection means for detecting a boundary between a radiation field mask and a radiation field in the radiograph, based on the input image including the radiograph; and

image density correction means for carrying out density correction that causes densities of images in two neighboring regions sandwiching the detected boundary in the radiograph to become closer to each other. In this case,

the judgment processing means judges the image type of the radiograph by applying the judgment means to the radiograph having been subjected to the density correction.

The program of the present invention may cause the computer to function as:

mask boundary detection means for detecting the boundary between the radiation field mask and the radiation field in the radiograph, based on the input image including the radiograph; and

characteristic quantity adjustment means for adjusting values of the characteristic quantities in a region over the detected boundary in the radiograph so as to suppress contribution of the characteristic quantities to the judgment.

The image-corresponding region size refers to an actual size of an imaging plate or a flat panel detector or the like used in radiography of the radiograph, for example. In the case where an actual size corresponding to one pixel in the radiograph has been identified, the image-corresponding region size can be found by the number of pixels in the long and short sides of the radiograph.

The image-corresponding region size may be obtained directly from hardware at the time of reading of the radiograph.

Instead of the image-corresponding region size, information that can identify at least an actual size of a subject may be used by adopting a gauge or the like representing an actual size for one pixel in the radiograph.

The radiographed parts refer to a chest, an abdomen, lumbar bones, a hip joint, upper arm bones, and the like. The radiography directions refer to radiography from the front, from a side direction, and from the above of a subject, for example. The radiography methods may be radiography with a contrast agent, radiography without a contrast agent, plane radiography, tomography, and the like.

The radiation field refers to a region on which a radiation is irradiated in normal dose. The radiation field mask is a shield plate that narrows the radiation field by covering a part of a subject that is not necessary for image interpretation, in order to reduce exposure to the radiation.

The various kinds of characteristic quantities may include the image-corresponding region size.

The edge component refers to an outline that appears due to density differences in an image. For example, the edge component may be represented by the first or second derivative between neighboring pixels, a wavelet coefficient, or an output value of a Haar-like filter that outputs a difference between two arbitrary rectangular regions, for example.

The density refers to a general signal level representing magnitude of a detected radiation rather than a signal space, and signal correction processing may be carried out in any space.

According to the apparatus, the method, and the program of the present invention for image type judgment, the judgment means is generated and prepared through the machine learning using the sample images that are prepared for and belong to the respective image types predefined by one or more of the items out of the radiographed parts, the radiography directions, and the radiography methods, in order to judge which of the image types a target image belongs to based on the various characteristic quantities of the target image. By applying the judgment means to the radiograph in the input image, which of the image types the radiograph belongs to is judged. Therefore, the type of an image having complex density patterns and having been difficult to judge can be judged with a characteristic of the judgment means generated through the machine learning using the sample images, that is, with high accuracy of judgment and high robustness. Accordingly, the judgment can be carried out on which of the image types defined by the radiographed parts, the radiography directions, and the radiography methods the radiograph belongs to.

In the apparatus, the method, and the program of the present invention, in the case where the image type of the radiograph is judged by applying the judgment means on the radiograph after the boundary between the radiation field mask and the radiation field has been detected in the radiograph included in the input image and the density correction has been carried out on the radiograph so as to cause the densities of the two neighboring regions sandwiching the detected boundary in the radiograph to become closer to each other, information on the radiation field mask and other information on the radiograph can be separately reflected in the characteristic quantities, and performance of the image type judgment can thus be improved.

In the case where the image type of the radiograph is judged by applying the judgment means on the radiograph after the boundary between the radiation field mask and the radiation field has been detected in the radiograph and the values of the characteristic quantities have been adjusted so as to suppress contribution of the characteristic quantities to the judgment based on the region over the detected boundary, the information on the radiation field mask and other information on the radiograph can be separately reflected in the characteristic quantities, and performance of the image type judgment can therefore be improved.

### BRIEF DESCRIPTION OF THE DRAWINGS

FIG. 1 is a block diagram showing the configuration of an image type judgment apparatus of a first embodiment of the present invention;

FIG. 2 shows an input image including a radiograph;

FIG. 3 shows Sobel filters for detecting edge components;

FIG. 4 shows an edge-extracted image represented only by pixels comprising the edge components;

FIG. 5 shows a graph in a polar coordinate system as a space of Hough transform;

FIG. 6 shows the radiograph wherein a mask boundary has been determined;

FIG. 7 shows density correction carried out on a normalized radiograph;

FIG. 8 shows a cumulative histogram of density in a normalized density-corrected radiograph;

FIG. 9 shows multi-resolution conversion on the normalized density-corrected radiograph;

FIG. 10 shows generation of classifiers by an Adaboost learning algorithm;

FIG. 11 shows sample images used in the Adaboost learning algorithm;

FIG. 12 shows the flow of processing in the image type judgment apparatus in the first embodiment;

FIG. 13 is a block diagram showing the configuration of an image type judgment apparatus of a second embodiment of the present invention; and

FIG. 14 shows the flow of processing in the image type judgment apparatus in the second embodiment.

### DESCRIPTION OF THE PREFERRED EMBODIMENTS

Hereinafter, embodiments of the present invention will be described. An image type judgment apparatus as an embodiment of the present invention described below uses as an input image a reduced image of a radiograph. The reduced image is obtained by a pre-reading processing as low-resolution image reading carried out in a preliminary manner for finding optimal image reading conditions before a final reading processing as high-resolution image reading is performed by a reading apparatus. The reading apparatus reads the radiograph through detection of fluorescent light emitted by scanning an imaging plate (IP) storing the radiograph generated by exposure to a radiation that has passed a subject with a stimulating ray. The image type judgment apparatus judges which of a plurality of image types, predefined by radiography menus, that is, image types defined by radiographed parts, radiography directions, radiography methods, and the like the radiograph of the input image belongs to. The image type judgment apparatus carries out the judgment by using classifiers for various target image types generated by machine learning. In the description below, an image and image data representing the image are not distinguished.

### First Embodiment

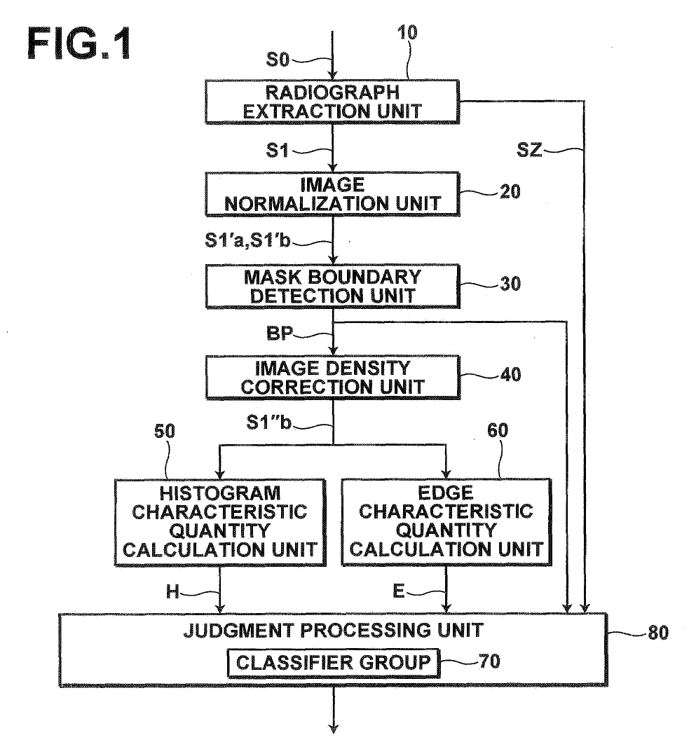

FIG. 1 is a block diagram showing the configuration of an image type judgment apparatus of a first embodiment of the present invention. As shown in FIG. 1, the image type judgment apparatus comprises a radiograph extraction unit 10, an image normalization unit 20, a mask boundary detection unit 30, an image density correction unit 40, a histogram characteristic quantity calculation unit 50, an edge characteristic quantity calculation unit 60, and a judgment processing unit (the judgment processing means) 80 having a classifier group (the judgment means) 70.

The radiograph extraction unit 10 extracts a radiograph from an input image S0, based on the input image S0. More specifically, the radiograph extraction unit 10 projects values of pixels in the input image S0 in a horizontal direction and in a vertical direction, and detects ranges in the horizontal and vertical directions where the projected values are mostly 0 (the value of pixels that do not form an image). The radiograph extraction unit 10 extracts an image in a rectangular region determined from the detected horizontal and vertical ranges as a radiograph S1.

The input image S0 has a uniform size of 256×256 pixels, and one pixel therein corresponds to a specific actual size. Therefore, in the case where a radiograph is pre-read from an imaging plate having a different size, the pre-reading image is included in the 256×256 pixels wherein the actual size is reflected in the number of pixels excluding pixels having the value of 0 representing a remaining region.

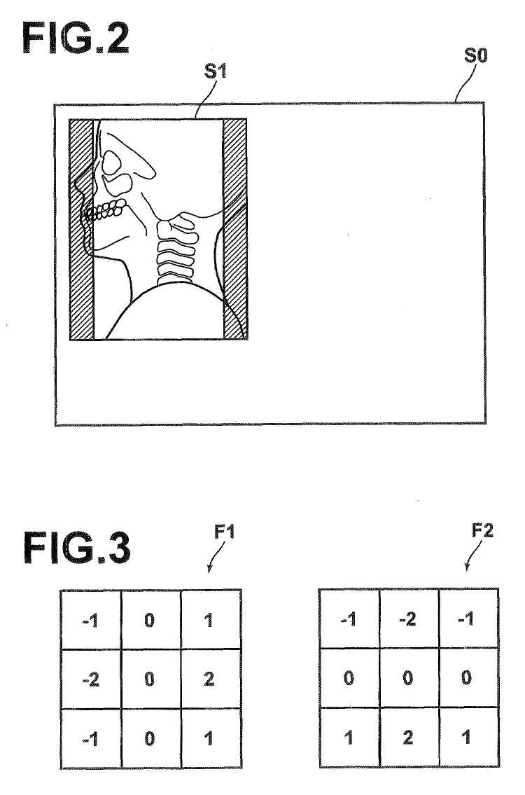

FIG. 2 shows an example of the input image S0 including a radiograph of the neck of a human body radiographed laterally.

The radiograph extraction unit 10 regards a size defined by a combination of lengths of the long and short sides of the extracted radiograph S1 as a size of the imaging plate used for the radiography, and obtains IP size information SZ (the image-corresponding region size) thereof. The actual size corresponding to one pixel in the radiograph S1 is often identified in advance. Therefore, by finding the number of pixels in the long and short sides of the radiograph S, the actual IP size can be known. For example, the IP size is classified into 6 sizes (corresponding to 383.5×459.0 mm, 383.5×383.0 mm, 281.5×332.0 mm, 203.0×254.0 mm and so on of photograph sizes) as shown in Table 1, and information representing which of the 6 sizes the combination of the lengths of the long and short sides of the radiograph S1 corresponds to is used as the IP size information SZ.

TABLE 1

| Types of IP Sizes | Long side (Pixels) | Short side (Pixels) |
|---|---|---|
| 1 | >210 | >210 |
| 2 | >210 | ≦210 |
| 3 | 180~210 | — |
| 4 | 150~180 | >120 |
| 5 | 150~180 | ≦120 |
| 6 | ≦150 | — |

The IP size is highly likely to be a size that is specific to a radiographed part, the pose of a subject, and a radiography method. Therefore, the IP size is correlated to the image type of the radiograph S1. Consequently, the IP size information SZ is an important clue to judge the image type of the radiograph S1.

The image normalization unit 20 cuts the radiograph S1 extracted by the radiograph extraction unit 10 from the input image S0, and normalizes the radiograph S1 by administering resolution conversion processing thereon to generate a normalized radiograph S1′ having a predetermined resolution.

This normalization processing is carried out to cause the radiograph to be appropriate for processing such as detection of mask boundaries and calculation of histogram characteristic quantities and edge characteristic quantities that will be described later. More specifically, the normalization processing generates a normalized radiograph S1′a having 128×128 pixels for the mask boundary detection and a normalized radiograph S1′b of 32×32 pixels for the calculation of histogram characteristic quantities and edge characteristic quantities, through execution of affine transform or the like that can change an aspect ratio of the radiograph S1.

The mask boundary detection unit 30 detects a boundary B (hereinafter referred to as a mask boundary) that divides the normalized radiograph S1′a into a part corresponding to a radiation field and a part corresponding to a radiation field mask, and obtains position information BP representing a position of the mask boundary B. This processing is equivalent to detecting the mask boundary that divides the radiograph S1 into a part corresponding to the radiation field and a part corresponding to the radiation field mask.

The mask is used to reduce exposure of the subject to radiation as much as possible, and reduces the radiation dose to a region including a part that is not a region of interest by covering the region with a predetermined material. The position of the covered part often varies depending on the radiographed part and the purpose of the radiography. The image type of the radiograph S1 is correlated to the shape of the mask and the position of the mask. Consequently, the position information BP of the mask boundary B is an important clue to judge the image type of the radiograph S1.

How the mask boundary detection unit 30 detects the mask boundary B will be described next. Since the radiation dose is different between the radiation field and the part covered with the mask in a radiographed region as has been described above, density becomes different between the part corresponding to the radiation field and the part corresponding to the mask. The mask boundary B can be found by using this characteristic. Firstly, a first Sobel filter F1 for detecting a horizontal edge component and a second Sobel filter F2 for detecting a vertical edge component shown in FIG. 3 are applied to each pixel of the normalized radiograph S1′a therein, and an output value T1 from the first Sobel filter F1 and an output value T2 from the second Sobel filter F2 are calculated for each of the pixels. A root mean square (RMS) of the output values T1 and T2 is found, and pixels whose RMS value is equal to a predetermined threshold value or larger are extracted as pixels comprising edge components extending in arbitrary directions. An edge-extracted image S1e represented only by the pixels comprising the edge components is then obtained. A group of straight lines passing the respective pixels comprising the edge components in the edge-extracted image S1e is projected onto a Hough transform space, that is, onto a space whose two axes are p representing lengths of perpendiculars to lines passing the respective pixels from the origin of an xy coordinate system of the edge-extracted image S1e and θ representing angles between the perpendiculars and the x axis. In this manner, a graph of curves corresponding to the respective pixels is generated in the polar coordinate system. By detecting a point (an extremely small region) at which the curves intersect a predetermined number of times or more, a straight line in the normalized radiograph S1′ is detected and determined as the mask boundary B.

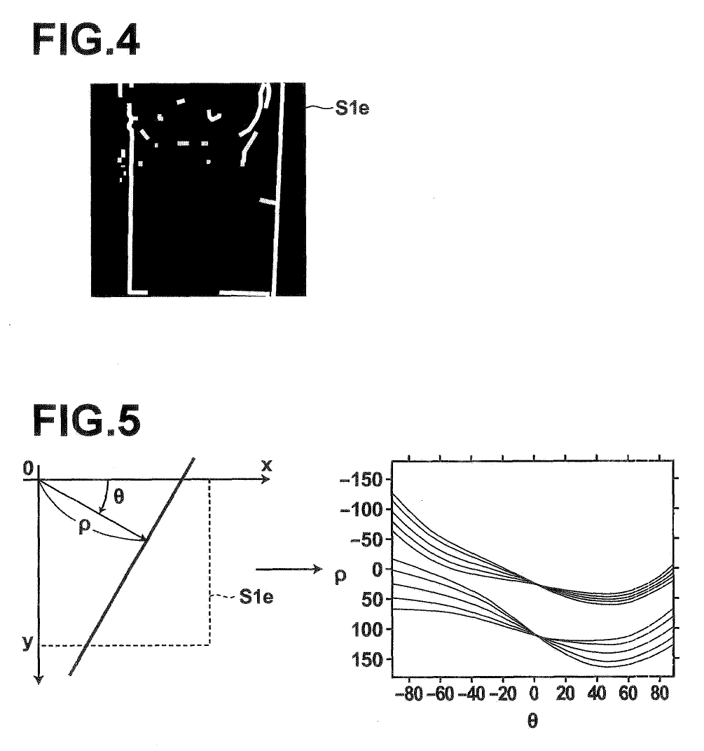

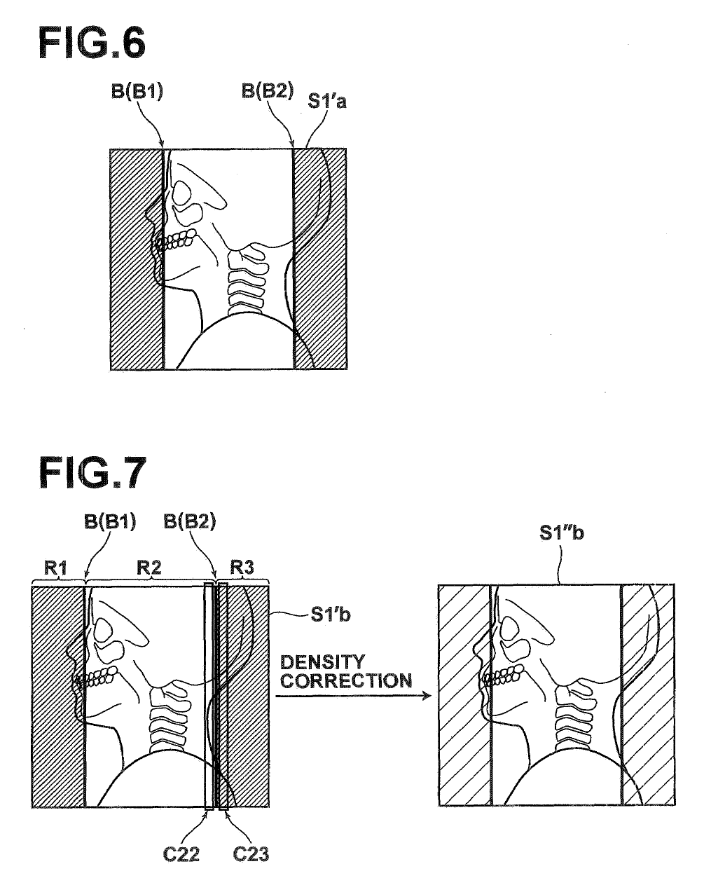

FIG. 4 shows the edge-extracted image S1e obtained from the radiograph of the neck shown in FIG. 2, and FIG. 5 shows the Hough transform carried out on the edge-extracted image S1e and the graph in the polar coordinate system obtained through the Hough transform. FIG. 6 is the radiation image S1 wherein the mask boundary B has been detected.

In this embodiment, a case where the shape of the mask is a rectangle is described. However, in the case where the shape is an ellipse, the mask boundary B can be detected through the Hough transform in the same manner.

The image density correction unit 40 carries out density correction to cause the densities of regions sandwiching the mask boundary B in the normalized radiograph S1′ to become closer to each other, and obtains a normalized density-corrected radiograph S1′b. This process is equivalent to carrying out density correction to cause the densities of regions sandwiching the mask boundary B in the radiograph S1 to become closer to each other.

The density correction of the normalized radiograph S1′b is carried out so that uneven density between the part corresponding to the radiation field and the part corresponding to the mask in the normalized radiograph S1b does not cause an adverse effect on calculation of the histogram characteristic quantities and the edge characteristic quantities that will be described later.

How the image density correction unit 40 carries out the density correction will be described below. Firstly, the normalized radiograph S1′b is divided into image regions whose boundaries include the mask boundary B. Thereafter, the image density correction unit 40 sets a target region of density comparison within a predetermined distance from the mask boundary B on each of two neighboring image regions sandwiching the mask boundary B, and carries out density correction processing on at least either one of the image regions as gradation conversion processing that causes a mean value of pixels in either one of the density comparison target regions to approximately agree with a mean value of pixels in the other density comparison target region, for each pair of the image regions sandwiching the mask boundary B. In the case where the number of the image regions is 3 or more, the gradation conversion processing is carried out only on either one of the two neighboring image regions sandwiching the mask boundary B so that the image region whose density has been corrected cannot be updated by the density correction processing that is carried out later, and the density correction processing is carried out sequentially on each pair, excluding the first pair, of one of the image regions having been subjected to the density correction processing and the other one of the image regions not having been subjected to the density correction processing.

FIG. 7 shows the normalized radiograph S1′b divided into image regions R1, R2, and R3 sandwiching mask boundaries B1 and B2 and density comparison target regions C22 and C23 set in the image regions R2 and R3 sandwiching the mask boundary B2, as well as the normalized density-corrected radiograph S1″b generated by the density correction processing on the normalized radiograph S1′b. As an example of the density correction processing in this case, gradation conversion processing according to Equation (1) below may be carried out on the image region R3:

R3′=R3+(a mean pixel value in C22−a mean pixel value in C23) (1)

As an easier method of the density correction processing, gradation conversion processing that causes mean pixel values of the two neighboring image regions sandwiching the mask boundary B to approximately agree with each other may be carried out on at least one of the two image regions, without setting the density comparison target regions.

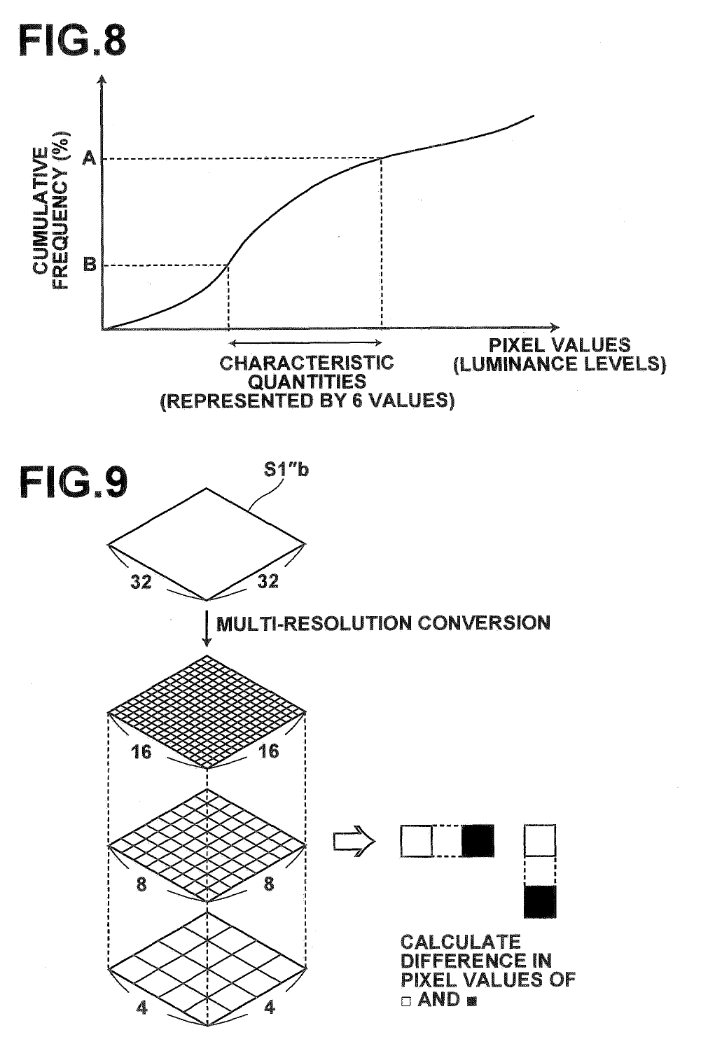

The histogram characteristic quantity calculation unit 50 analyzes the density distribution in the normalized density-corrected radiograph S1″b, and obtains the characteristic quantities representing indices regarding the density distribution. This processing is equivalent to analysis of density distribution and calculation of the characteristic quantities representing the indices regarding the density distribution in the radiograph S1. More specifically, the histogram characteristic quantity calculation unit 50 generates a cumulative histogram of pixel values (luminance levels) in the normalized density-corrected radiograph S1″b as shown in FIG. 8, and calculates differences between the pixel values for the cases of cumulative frequency being A % (5≦A≦95) and B % (1≦B≦95), for one or more combinations of A and B whose values are different and predetermined. The calculated differences are represented by 6 values and used as histogram characteristic quantities (density distribution characteristic quantities) H.

The cumulative histogram reflects information of contrast or the like caused by a ratio of the radiographed part to the radiographed region and by tissue structures of the radiographed part. Therefore, the image type of the radiograph S1 is correlated to the cumulative histogram, and the histogram characteristic quantities H are also important clues to judge the image type of the radiograph S1.

The edge characteristic quantity calculation unit 60 calculates characteristic quantities representing directions and/or positions of the edge components in the normalized density-corrected radiograph S1″b, and this processing is equivalent to calculation of the characteristic quantities representing the directions and/or positions of the edge components in the radiograph S1. More specifically, the edge characteristic quantity calculation unit 60 carries out multi-resolution conversion on the normalized density-corrected radiograph S1″b having 32 pixels in each side as shown in FIG. 9, and generates 3 images having 16 pixels, 8 pixels, and 4 pixels in each side. In this manner, 4 types of resolution planes are generated including the original 32 pixels in each side, and a difference in values of two pixels in each of the planes is calculated for each predetermined combination of positions of the two pixels. The calculated values are represented by 8 values and used as edge characteristic quantities E. The positions of the two pixels comprising each of the combinations are horizontally or vertically aligned.

The difference in the values of two pixels in each of the resolution planes reflects information of an outline representing a shape of the radiographed part and an outline of tissues comprising the radiographed part. Therefore, the image type of the radiograph S1 is correlated to the differences, and the edge characteristic quantities E are also important clues to judge the image type of the radiograph S1.

The classifier group 70 is generated through machine learning using sample images belonging to a predetermined one of image types defined by one or more of items including a radiographed part and sample images belonging to the other image. types. The items are radiographed parts, poses of subjects, radiography directions, radiography methods, and the like. The classifier group 70 comprises various types of classifiers whose detection targets are the different image types, and each of the classifiers judges whether an image as a target of judgment belongs to the image type as the detection target thereof, based on various characteristic quantities of the target image.

The radiographed parts may be facial bones, neck bones, a chest, a breast, an abdomen, lumbar bones, a hip joint, upper arm bones, forearm bones, a wrist joint, a knee joint, an ankle joint, and a foot, for example. The radiography directions may be frontal and lateral directions, for example. The poses of subjects refer to a standing position, a recumbent position, and an axial position, for example. The radiography methods are plain radiography, tomography, and the like. The image types are predefined by combinations of the radiographed parts, the radiography directions, the poses, the radiography methods, and the like.

The classifiers generated through the machine learning using the sample images may be support vector machines, neural networks, or classifiers generated by boosting, for example.

The various kinds of characteristic quantities include the image size corresponding to the IP size, the position information BP of the mask boundary B, the histogram characteristic quantities H, and the edge characteristic quantities E, for example.

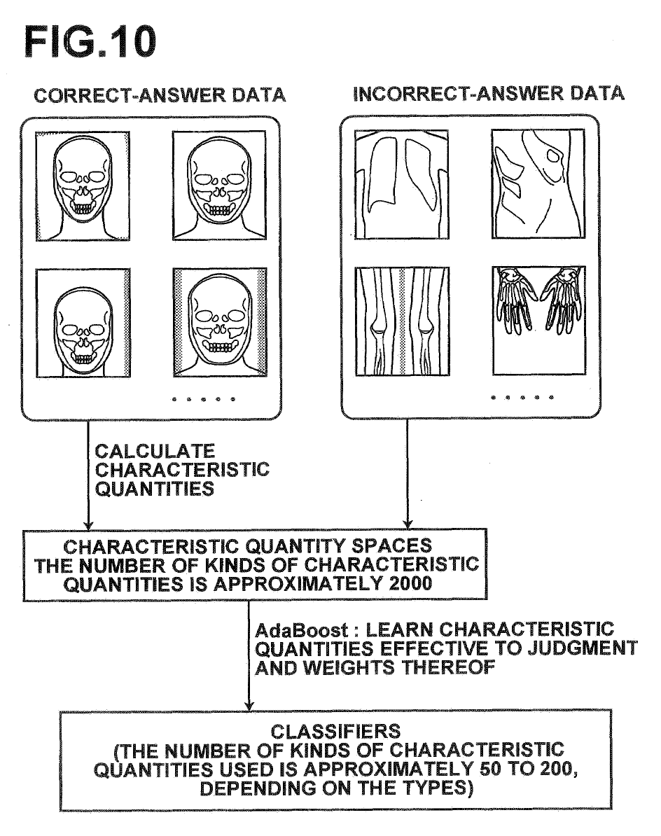

In this embodiment, the classifiers are generated by using an Adaboost learning algorithm as one type of boosting. More specifically, as shown in FIG. 10, sample images belonging to a predetermined one of the image types as correct-answer image data belonging to the type to be judged are prepared as well as sample images belonging to the other image types as incorrect-answer image data not belonging to the image type to be judged. Image data representing each of the sample images are projected onto a predetermined characteristic quantity space, and the predefined characteristic quantities are calculated. Whether each of the sample images represents an image which is a correct answer is then judged by use of the characteristic quantities, and the kinds of the characteristic quantities and weights therefor that are effective for the judgment are learned from a result of the judgment. In this manner, the classifier that judges whether a target image belongs to the image type is generated.

The correct image data used in the learning are correct image data sets of several thousands of patterns obtained by right-left reversal processing and translation carried out on correct image data sets of several hundreds of patterns in which rotation directions in image planes corresponding to axes of subjects in the images have been arranged in a specific direction. The incorrect image data used for the training are obtained by random rotation processing in 0, 90, 180, or 270 degrees on incorrect image data sets of approximately 1500 patterns.

This learning is carried out for each of the image types to be judged, and the classifiers are generated for the predefined various image types to be judged. The number of the kinds of all the characteristic quantities is approximately 2000, and each of the classifiers uses 50 to 200 kinds of characteristic quantities.

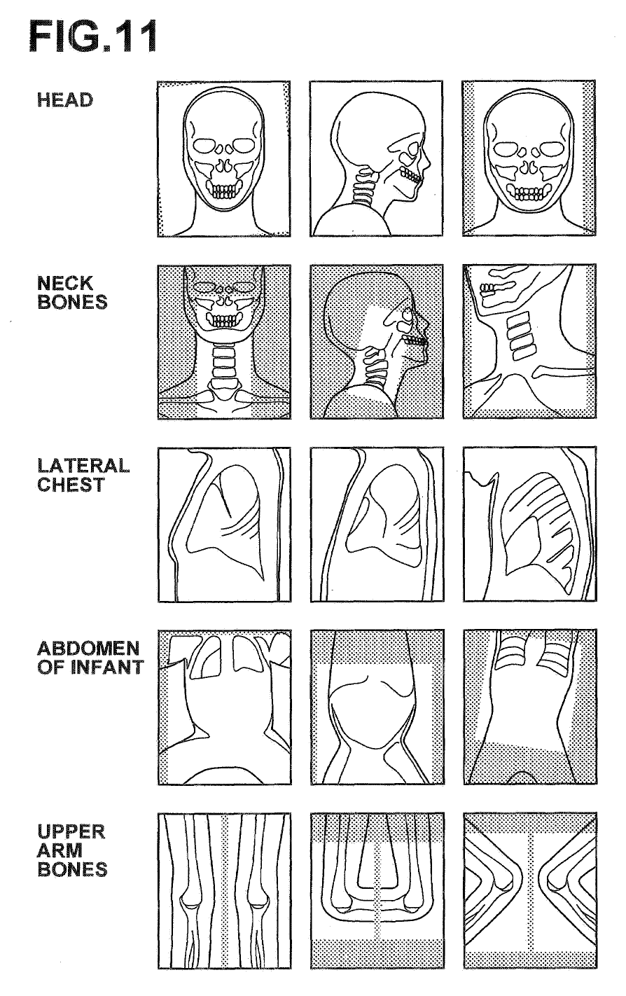

FIG. 11 shows sample images used for the learning, which are sample images of heads, neck bones, lateral chests, the abdomens of infants, and upper arm bones are shown.

The judgment processing unit 80 judges the image type of the radiograph S1 by using at least one of the classifiers comprising the classifier group 70, based on the characteristic quantities having been obtained regarding the radiograph S1, that is, the characteristic quantities including the IP size information SZ, the mask boundary position information BP, the histogram characteristic quantities H, and the edge characteristic quantities E. This processing is equivalent to judging the image type of the radiograph S1 by applying at least one of the classifiers comprising the classifier group 70 to the radiograph S1.

For example, the judgment processing unit 80 sequentially applies the classifiers comprising the classifier group 70 to the radiograph S1 extracted by the radiograph extraction unit 10, and judges whether the radiograph S1 belongs to a predetermined one of the image types. In the case where an affirmative result has been obtained, the judgment processing unit 80 judges that the radiograph S1 belongs to the image type regarding which the affirmative result has been obtained. Each of the classifiers generally calculates a score representing a probability that the radiograph S1 belongs to the image type to be judged by the classifier. Therefore, the classifiers of all the types may be applied to the radiograph S1, and the image type corresponding to the classifier showing the largest score may be determined as the image type of the radiograph S1.

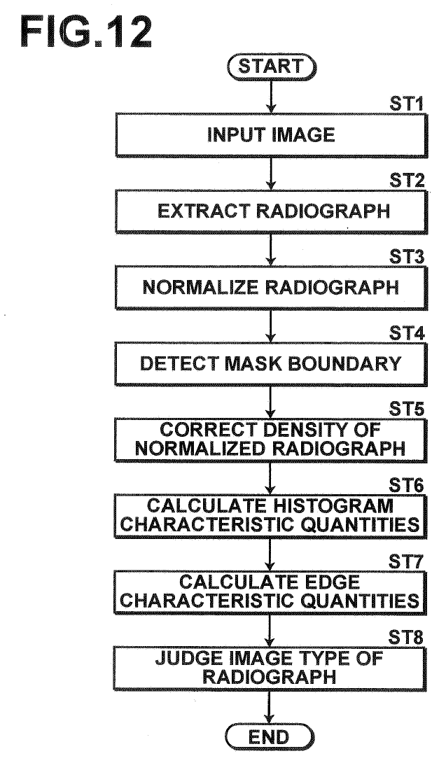

The flow of processing in the image type judgment apparatus in the first embodiment will be described below. FIG. 12 is a flow chart showing the flow of processing in the image type judgment apparatus.

When the image S0 including the radiograph S1 is input to the image type judgment apparatus (Step ST1), the radiograph extraction unit 10 extracts as the radiograph S the rectangular image region wherein few pixel values are 0 from the input image S0, and obtains the size information of the radiograph S1 as the IP size information SZ (Step ST2).

The image normalization unit 20 cuts the radiograph S1 from the input image S0, and carries out affine transform or the like on the radiograph S1 to generate the normalized radiograph S1′a of 128×128 pixels for the mask boundary detection processing and the normalized radiograph S1′b of 32×32 pixels for the calculation of the histogram characteristic quantities H and the edge characteristic quantities E (Step ST3).

The mask boundary detection unit 30 detects the mask boundary B by applying Hough transform on the normalized radiograph S1′a, and obtains the position information BP of the mask boundary B in the radiograph S1 (Step ST4).

The image density correction unit 40 divides the normalized radiograph S1′b into the image regions whose boundaries include the mask boundary B, and sets the density comparison regions at the predetermined distance from the mask boundary B in each of the two neighboring image regions sandwiching the mask boundary B. The image density correction unit 40 then carries out the density correction processing on at least either one of the image regions as the gradation conversion processing that causes the mean values of the pixel values to approximately agree with each other in the density comparison regions, for each of the combinations of the two neighboring image regions sandwiching the mask boundary B. In this manner, the image density correction unit 40 corrects the density of the entire normalized radiograph S1′b, and obtains the normalized density-corrected radiograph S1″b (Step ST5).

After generation of the normalized density-corrected radiograph S1″b, the histogram characteristic quantity calculation unit 50 generates the cumulative histogram of the pixel values therein, and calculates the difference in the pixel values for the cases where the cumulative frequency is A % (5≦A≦95) and B % (1≦B≦95), for one or more of the combinations of the different predetermined values of A and B. The histogram characteristic quantity calculation unit 50 expresses the calculated differences by the 6 values used as the histogram characteristic quantities H (Step ST6).

The edge characteristic quantity calculation unit 60 carries out the multi-resolution conversion on the normalized density-corrected radiograph S1″b of 32×32 pixels, and generates the radiographs in 3 resolutions whose sides are 16, 8, and 4 pixels each. In this manner, the edge characteristic quantity calculation unit 60 prepares the 4 resolution planes, and calculates the difference in 2 pixel values in each of the planes, for each of the predetermined combinations of the positions of the 2 pixels. The edge characteristic quantity calculation unit 60 expresses the calculated values by the 8 values that are used as the edge characteristic quantities E (Step ST7).

The judgment processing unit 80 sequentially uses the classifiers comprising the classifier group 70 for judging whether the radiograph S1 is an image of a predetermined one of the image types, based on the various characteristic quantities including the IP size information SZ, the mask boundary information BP, the histogram characteristic quantities H and the edge characteristic quantities E having been calculated. The judgment processing unit 80 judges that the radiograph S1 belongs to the image type regarding which the result of the judgment has become affirmative (Step ST8).

### Second Embodiment

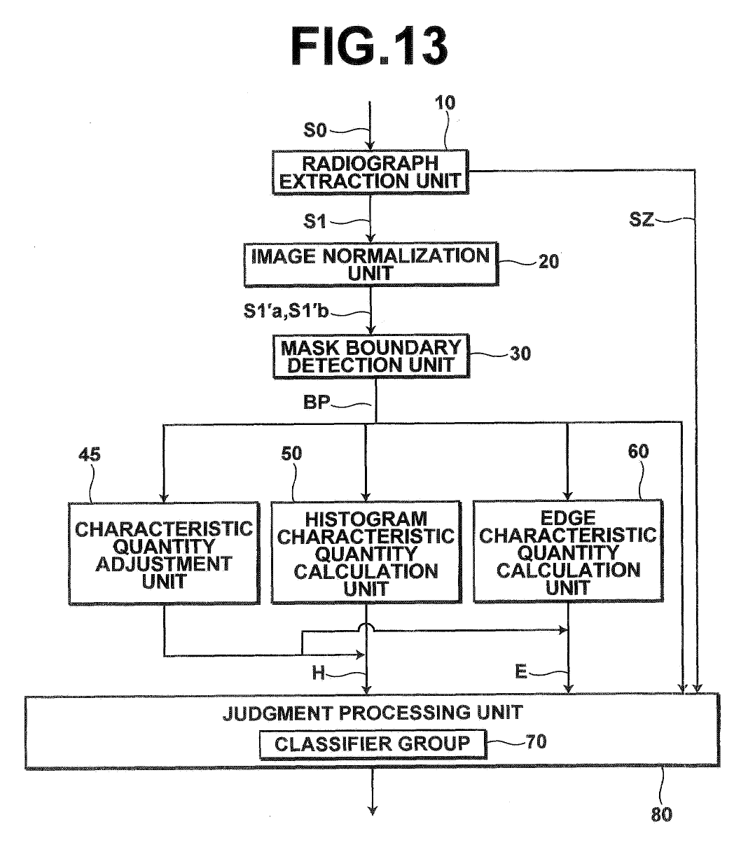

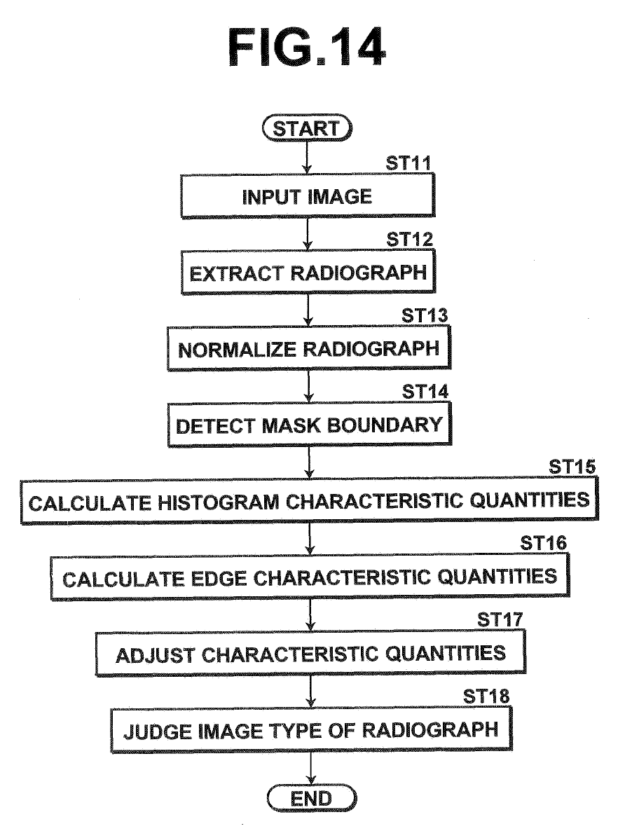

FIG. 13 is a block diagram showing the configuration of an image type judgment apparatus as a second embodiment of the present invention. As shown in FIG. 13, the image type judgment apparatus comprises a radiograph extraction unit 10, an image normalization unit 20, a mask boundary detection unit 30, a histogram characteristic quantity calculation unit 50, an edge characteristic quantity calculation unit 60, a characteristic quantity adjustment unit 45, and a judgment processing unit 80 having a classifier group 70.

The radiograph extraction unit 10 extracts as a radiograph S1 a rectangular image wherein few pixel values are 0 in an input image S0 including the radiograph S, in the same manner as in the first embodiment. The radiograph extraction unit 10 obtains a size defined by a combination of the long and short sides of the extracted radiograph S1 as IP size information SZ.

The image normalization unit 20 cuts the radiograph S1 extracted by the radiograph extraction unit 10 from the input image S0, and carries out resolution conversion processing on the radiograph S1, in the same manner as in the first embodiment. In this manner, the image normalization unit 20 obtains a normalized radiograph S1′a of 128×128 pixels for mask boundary detection and a normalized radiograph S1′b of 32×32 pixels for calculation of histogram characteristic quantities and edge characteristic quantities.

The mask boundary detection unit 30 detects a mask boundary B that divides the normalized radiograph S1′a into a part corresponding to a radiation field and a part corresponding to a radiation field mask, and obtains position information BP representing a position of the mask boundary B, in the same manner as in the first embodiment.

The histogram characteristic quantity calculation unit 50 calculates histogram characteristic quantities H in the normalized radiograph S1′b, in the same manner as in the first embodiment.

The edge characteristic quantity calculation unit 60 calculates edge characteristic quantities E in the normalized radiograph S1′b in the same manner as in the first embodiment.

The classifier group 70 comprises classifiers whose detection-target image types are different from each other. Each of the classifiers has been generated through learning in the same manner as in the first embodiment, and judges whether the type of a target image is a predetermined one of the image types, based on various kinds of characteristic quantities in the target image, that is, characteristic quantities including the IP size information SZ, the mask boundary position information BP, the histogram characteristic quantities H, and the edge characteristic quantities E.

The judgment processing unit 80 judges the image type of the radiograph S1 in the same manner as in the first embodiment. The judgment processing unit 80 judges the image type of the radiograph S1 by using at least one of the classifiers comprising the classifier group 70, based on the various characteristic quantities having been obtained regarding the radiograph S1, that is, the characteristic quantities including the IP size information SZ, the mask boundary position information BP, the histogram characteristic quantities H, and the edge characteristic quantities E.

The characteristic quantity adjustment unit 45 adjusts values of edge characteristic quantities Ea in a region over the mask boundary B in the normalized radiograph S1′b so as to suppress contribution thereof to the image type judgment. The characteristic quantity adjustment unit 45 changes the values of the characteristic quantities Ea to 0. In this manner, a rate of contribution of the edge characteristic quantities Ea to the image type judgment is reduced, and an adverse effect caused by uneven density that changes across the mask boundary B can be reduced on the edge characteristic quantities. Another method of adjusting the edge characteristic quantities Ea may be used so as to obtain the same result as in the case of absence of the mask boundary B.

The flow of processing carried out in the image type judgment apparatus in the second embodiment will be described next. FIG. 13 is a flow chart showing the flow of processing in the image type judgment apparatus in the second embodiment.

When the image S0 including the radiograph S1 is input to the image type judgment apparatus (Step ST11), the radiograph extraction unit 10 extracts as the radiograph S a rectangular region wherein few pixel values are 0 from the input image S0, and obtains the size information of the radiograph S1 as the IP size information SZ (Step ST12).

The image normalization unit 20 cuts the radiograph S1 from the input image S0, and carries out affine transform or the like on the radiograph S to generate the normalized radiograph S1′a of 128×128 pixels for mask boundary detection processing and the normalized radiograph S1′b of 32×32 pixels for calculation of the histogram characteristic quantities H and the edge characteristic quantities E (Step ST13).

The mask boundary detection unit 30 detects the mask boundary B by applying Hough transform on the normalized radiograph S1′a, and obtains the position information BP of the mask boundary B in the radiograph S1 (Step ST14).

After the mask boundary position information BP has been obtained, the histogram characteristic quantity calculation unit 50 generates a cumulative histogram of pixel values in the normalized radiograph S1′b, and calculates a difference in pixel values for the cases where the cumulative frequency is A % (5≦A≦95) and B % (1≦B≦95), for one or more of combinations of different predetermined values of A and B. The histogram characteristic quantity calculation unit 50 expresses the calculated differences by 6 values used as the histogram characteristic quantities H (Step ST15).

The edge characteristic quantity calculation unit 60 carries out multi-resolution conversion on the normalized radiograph S1′b of 32×32 pixels, and generates radiographs in 3 resolutions whose sides are 16, 8, and 4 pixels each. In this manner, the edge characteristic quantity calculation unit 60 prepares the 4 resolution planes, and calculates a difference in 2 pixel values in each of the planes, for each of predetermined combinations of positions of the 2 pixels. The edge characteristic quantity calculation unit 60 expresses the calculated values by 8 values that are used as the edge characteristic quantities E (Step ST16).

After the edge characteristic quantities E have been calculated, the characteristic quantity adjustment unit 45 replaces with 0 the values of the edge characteristic quantities Ea in the region over the mask boundary B in the normalized radiograph S1′b so as to suppress the contribution thereof to the image type judgment (Step ST17).

The judgment processing unit 80 sequentially uses the classifiers comprising the classifier group 70 for judging whether the radiograph S1 is an image of a predetermined one of the image types, based on the various characteristic quantities including the IP size information SZ, the mask boundary information BP, the histogram characteristic quantities H and the edge characteristic quantities E having been calculated for the radiograph S1. The judgment processing unit 80 judges that the radiograph S1 belongs to the image type regarding which a result of the judgment has become affirmative (Step ST18).

As has been described above, according to the image type judgment apparatuses in the first and second embodiments of the present invention, the classifier group 70 is generated and prepared through the machine learning using the sample images that are prepared for and belong to the respective image types predefined by one or more of the items out of the radiographed parts, the radiography directions, the radiography methods, in order to judge which of the image types a target image belongs to based on the various characteristic quantities of the target image. By applying the classifier group 70 to the radiograph S1 in the input image S0, which of the image types the radiograph S1 belongs to is judged. Therefore, the type of an image having complex density patterns and having been difficult to judge can be judged with a characteristic of the classifiers generated through the machine learning using the sample images, that is, with high accuracy of judgment and high robustness. Accordingly, the judgment can be carried out on which of the image types defined by the radiographed parts, the radiography directions, and the radiography methods the radiograph belongs to.

Furthermore, in the image type judgment apparatus in the first embodiment, the mask boundary B is detected as the boundary between the radiation field and the radiation field mask in the normalized radiograph S1′a corresponding to the radiograph S1, based on the input image S0 including the radiograph S1. The density correction processing is then carried out so as to cause the densities to become closer in every two neighboring regions sandwiching the boundary B in the normalized radiograph S1′b corresponding to the radiograph S1, and the image type of the radiograph S is judged by application of the classifier group 70 to the normalized density-corrected radiograph S1″b. Therefore, information on the radiation field mask and other information in the radiograph S1 can be reflected separately in the characteristic quantities, which can improve performance of the image type judgment.

In the image type judgment apparatus in the second embodiment of the present invention, the mask boundary B is detected in the radiograph S1 as the boundary between the radiation field and the radiation field mask, based on the input image S0 including the radiograph S. The values of the characteristic quantities in the region over the mask boundary B in the radiograph S1 are then adjusted so as to suppress contribution of the characteristic quantities to the image type judgment, and the image type of the radiograph S1 is judged by application of the classifier group 70 to the radiograph S1. Therefore, information on the radiation field mask and other information in the radiograph S1 can be reflected separately in the characteristic quantities, which can also improve performance of the image type judgment.

In the image type judgment apparatuses in the first and second embodiments of the present invention, the various kinds of characteristic quantities include the IP size information SZ as the image-corresponding region size, the histogram characteristic quantities H as the characteristic quantities regarding density distribution that represent indices regarding density distribution in the radiograph S1, and the edge characteristic quantities E representing directions and/or positions of the edge components in the radiograph S1. Therefore, the judgment can be made by using the characteristic quantities that are especially highly correlated to the image type of the radiograph S1, which improves performance of the image type judgment.

In the image type judgment apparatuses in the first and second embodiments of the present invention, the edge characteristic quantities E include the mask boundary position information BP as the characteristic quantities representing the position of the boundary between the radiation field and the radiation field mask in the radiograph S1. Therefore, the judgment can be made by further using the characteristic quantities that are highly correlated to the image type, which improves performance of the image type judgment. The edge characteristic quantities E may include characteristic quantities that represent not only the mask boundary position but also a boundary position of segmented-field radiography.

A judgment experiment using the image type judgment apparatuses carried out by the applicants of the present invention will be described next. The object of the experiment was to examine how much the kinds of the characteristic quantities used therein generate difference in the judgment performance, and the conditions and the results of the experiment were as follows:

Conditions

### Judgment Target Neck

Sample images:

The number of neck images=492

The number of images other than neck images=6957

Results

TABLE 2
Experiment Results

| | Correct | Incorrect |
|---|---|---|
| | Judgment | Judgment |
| Characteristic Quantities Used | Rate | Rate |
| Histogram Characteristic Quantities H | 82.1% | 10.3% |
| Alone | | |
| Edge Characteristic Quantities E Alone | 87.4% | 0.4% |
| Histogram Characteristic Quantities H + Edge | 89.8% | 0.4% |
| Characteristic Quantities E | | |

Correct judgment rate=a rate of the cases where neck sample images have been judged correctly as neck sample images

Incorrect judgment rate=a rate of the cases where sample images other than neck sample images have been judged incorrectly as neck sample images

As shown in the above, the judgment performance is the worst in the case where only the histogram characteristic quantities H were used. In addition, for the cases of similar incorrect judgment rates, the correct judgment rate is highest in the case that the histogram characteristic quantities H were used together with the edge characteristic quantities E.

Although the image type judgment apparatuses as the embodiments of the present invention have been described above, programs that cause a computer to execute the procedures in the apparatuses are also embodiments of the present invention. Computer-readable recording media storing the programs are also embodiments of the present invention.

What is claimed is:

1. An image type judgment apparatus comprising:
judgment means for judging which of a plurality of image types, predefined by one or more items out of radiographed parts, radiography directions, and radiography methods a target image belongs to, based on various kinds of characteristic quantities in the target image, the judgment means generated through machine learning using sample images belonging to and prepared for each of the image types; and
judgment processing means for carrying out judgment on which of the image types a radiograph included in an input image belongs to by applying the judgment means to the radiograph.

2. The image type judgment apparatus according to claim 1, further comprising:
mask boundary detection means for detecting a boundary between a radiation field mask and a radiation field in the radiograph, based on the input image including the radiograph; and
image density correction means for carrying out density correction causing densities of images in two neighboring regions sandwiching the detected boundary in the radiograph to become closer to each other, wherein
the judgment processing means judges the image type of the radiograph by applying the judgment means to the radiograph having been subjected to the density correction.

3. The image type judgment apparatus according to claim 1, further comprising:
mask boundary detection means for detecting a boundary between a radiation field mask and a radiation field in the radiograph, based on the input image including the radiograph; and
characteristic quantity adjustment means for adjusting values of the characteristic quantities in a region over the detected boundary in the radiograph so as to suppress contribution of the characteristic quantities to the judgment.

4. The image type judgment apparatus according to claim 1, wherein
the judgment means is classifiers of various types each having a different detection target and generated through machine learning using sample images belonging to one of the image types as the detection target thereof and sample images belonging to an image type different from the image type as the detection target, and
the judgment processing means carries out the judgment by applying at least one of the classifiers to the radiograph.

5. The image type judgment apparatus according to claim 1, wherein the machine learning is learning by Adaboost.

6. The image type judgment apparatus according to claim 1, wherein the various kinds of characteristic quantities include an edge characteristic quantity representing a direction and/or a position of an edge component in the radiograph.

7. The image type judgment apparatus according to claim 2, wherein
the judgment means is classifiers of various types each having a different detection target and generated through machine learning using sample images belonging to one of the image types as the detection target thereof and sample images belonging to an image type different from the image type as the detection target, and
the judgment processing means carries out the judgment by applying at least one of the classifiers to the radiograph.

8. The image type judgment apparatus according to claim 2, wherein the various kinds of characteristic quantities include at least one of a characteristic quantity representing a density histogram of the radiograph and a characteristic quantity representing an edge component in the radiograph.

9. The image type judgment apparatus according to claim 3, wherein
the judgment means is classifiers of various types each having a different detection target and generated through machine learning using sample images belonging to one of the image types as the detection target thereof and sample images belonging to an image type different from the image type as the detection target, and
the judgment processing means carries out the judgment by applying at least one of the classifiers to the radiograph.

10. The image type judgment apparatus according to claim 3, wherein the various kinds of characteristic quantities include at least one of a characteristic quantity representing a density histogram of the radiograph and a characteristic quantity representing an edge component in the radiograph.

11. The image type judgment apparatus according to claim 4, wherein the machine learning is learning by Adaboost.

12. The image type judgment apparatus according to claim 4, wherein the various kinds of characteristic quantities include an edge characteristic quantity representing a direction and/or a position of an edge component in the radiograph.

13. The image type judgment apparatus according to claim 6, wherein the edge characteristic quantity includes a characteristic quantity representing a position of a boundary between a radiation field mask and a radiation field in the radiograph or a boundary position of a field in the radiograph in the case where the radiograph has been generated by image stitching.

14. The image type judgment apparatus according to claim 6, wherein the various kinds of characteristic quantities include an image-corresponding region size representing a size of an actual region represented by the radiograph and a density distribution characteristic quantity representing an index regarding density distribution in the radiograph.

15. An image type judgment method comprising the steps of:
generating judgment means for judging which of a plurality of image types, predefined by one or more items out of radiographed parts, radiography directions, and radiography methods a target image belongs to, based on various kinds of characteristic quantities in the target image, the judgment means generated through machine learning using sample images belonging to and prepared for each of the image types; and
carrying out judgment on which of the image types a radiograph included in an input image belongs to by applying the judgment means to the radiograph.

16. The image type judgment method according to claim 15 further comprising, after the step of generating the judgment means, the steps of:
detecting a boundary between a radiation field mask and a radiation field in the radiograph, based on the input image including the radiograph; and
carrying out density correction causing densities of images in two neighboring regions sandwiching the detected boundary in the radiograph to become closer to each other, wherein
the step of carrying out judgment is the step of carrying out judgment on the image type of the radiograph by applying the judgment means to the radiograph having been subjected to the density correction.

17. The image type judgment method according to claim 15 further comprising, after the step of generating the judgment means, the steps of:
detecting a boundary between a radiation field mask and a radiation field in the radiograph, based on the input image including the radiograph; and
adjusting values of the characteristic quantities in a region over the detected boundary in the radiograph so as to suppress contribution of the characteristic quantities to the judgment.

18. A computer-readable recording medium storing a program causing a computer to function as:
judgment means for judging which of a plurality of image types, predefined by one or more items out of radiographed parts, radiography directions, and radiography methods a target image belongs to, based on various kinds of characteristic quantities in the target image, the judgment means generated through machine learning using sample images prepared for and belonging to each of the image types; and
judgment processing means for carrying out judgment on which of the image types a radiograph included in an input image belongs to by applying the judgment means to the radiograph.

19. The computer-readable recording medium according to claim 18, the program causing the computer to further function as:
mask boundary detection means for detecting a boundary between a radiation field mask and a radiation field in the radiograph, based on the input image including the radiograph; and
image density correction means for carrying out density correction causing densities of images in two neighboring regions sandwiching the detected boundary in the radiograph to become closer to each other, wherein
the judgment processing means judges the image type of the radiograph by applying the judgment means to the radiograph having been subjected to the density correction.

20. The computer-readable recording medium according to claim 18, the program further causing the computer to function as:
mask boundary detection means for detecting a boundary between a radiation field mask and a radiation field in the radiograph, based on the input image including the radiograph; and
characteristic quantity adjustment means for adjusting values of the characteristic quantities in a region over the detected boundary in the radiograph so as to suppress contribution of the characteristic quantities to the judgment.
